(19) United States
(12) Patent Application Publication
(10) Pub. No.: US 2024/0295910 A1
(43) Pub. Date: Sep. 5, 2024

(54) SERVERS, SYSTEMS AND METHODS FOR ACCURATELY MEASURING, ARCHIVING, AND PREDICTING ENERGY CONSUMPTION OF SOFTWARE

(71) Applicant: AVEVA SOFTWARE, LLC, Lake Forest, CA (US)

(72) Inventor: Klaus Graefensteiner, Mission Viejo, CA (US)

(21) Appl. No.: 18/594,978

(22) Filed: Mar. 4, 2024

Related U.S. Application Data
(60) Provisional application No. 63/449,873, filed on Mar. 3, 2023.

(51) Int. Cl. G06F 1/28; G06F 11/36

(52) U.S. Cl. CPC G06F 1/28; G06F 11/3612

(57) ABSTRACT

In some embodiments, the system is directed to servers, systems, and methods configured to accurately measure, archive, and predict energy consumption associated with the execution of software programs. In some embodiments, the system provides a solution to the problem of not being able to accurately measure the power used by a particular program or a group of programs. In some embodiments, system steps include receiving baseline and loaded power measurements of hardware running software, determining the amount of additional power used during one or more programs, and/or storing the additional power usage in association with the one or more programs as software power usage. In some embodiments, the system is configured to predict hardware failure times based on power usage. In some embodiments, the system is configured to generate power usage plans to extend hardware life. In some embodiments, the system is configured to determine customer software power usage for billing purposes.

### CROSS-REFERENCE TO RELATED APPLICATION

This application claims the benefit of and priority to U.S. Provisional Application No. 63/449,873, filed Mar. 3, 2023, which is incorporated herein by reference in its entirety.

### BACKGROUND

Current energy consumption measurement platforms do not have the capability of measuring an amount of energy consumed by a computer as the result of executing software. There is presently no way to distinguish the energy consumed by the processors executing software and the energy consumed by various hardware components in an idle state. There is also currently no way of accurately measuring the energy needs of different software programs.

Therefore, there is a need in the art for systems and methods for accurately determining the amount of energy software programs require to execute and for using that information to improve energy efficiency in various applications.

### SUMMARY

The disclosure is directed to a system and methods for measuring energy usage of software programs. In some embodiments, the system comprises one or more computers comprising one or more processors and one or more non-transitory computer readable media. In some embodiments, the one or more non-transitory computer readable media including program instructions stored thereon that when executed cause the one or more computers to execute a series of steps. In some embodiments, the steps represent methods of implementing the system. In some embodiments, the steps represent steps of an algorithm.

Some embodiments include a step to receive, by the one or more processors, a baseline power measurement from software executing hardware. In some embodiments, the software executing hardware includes various conventional hardware components for a computer and/or server, which may include, but are not limited to, processors (CPUs), memory modules (RAM), power supply units (PSUs), hard drives (HDDs/SSDs), cooling systems (fans, heat sinks), and motherboards. In some embodiments, these components are subject to wear and thermal stress, which can be exacerbated by high power consumption and can lead to increased failure rates over time.

In some embodiments, the baseline power measurement comprises a power usage of the software executing hardware and or one or more hardware components (references to software executing hardware and/or one or more hardware components may be used interchangeably when describing the metes and bounds of the system) during an idle time period. In some embodiments, the idle time period does not include the execution of a one or more programs. In some embodiments, the idle time does not include the execution of one particular program. In some embodiments, the idle time period includes a time where no software-as-a-service (SaaS) programs are being executed.

Some embodiments includes a step to execute, by the one or more processors, the one or more programs and/or the particular program using the software executing hardware. In some embodiments, the one or more software programs include SaaS programs.

Some embodiments include a step to receive, by the one or more processors, a loaded power measurement of the software executing hardware. In some embodiments, the loaded power measurement includes the baseline power measurement and an additional power measurement. In some embodiments, the additional power measurement comprises power used by the software executing hardware during the execution of one or more programs.

Some embodiments include a step to determine, by the one or more processors, the additional power measurement by determining a difference between the baseline power measurement and the loaded power measurement. Some embodiments include a step to store, by the one or more processors, a software power usage, the software power usage comprising the additional power measurement and an association of the additional power measurement to the one or more programs. Some embodiments include a step to execute, by the one or more processors, the one or more programs on the software executing hardware based on the software power usage.

In some embodiments, the one or more non-transitory computer readable media include further program instructions stored thereon that when executed cause the one or more computers to receive, by the one or more processors, a maintenance prediction for a hardware component of the software executing hardware. In some embodiments, the maintenance prediction includes a failure prediction for the hardware component. In some embodiments, the maintenance prediction includes a correlation between total power usage and the failure prediction. In some embodiments, the maintenance prediction includes a correlation between the software power usage and the failure prediction.

In some embodiments, the one or more non-transitory computer readable media include further program instructions stored thereon that when executed cause the one or more computers to determine, by the one or more processors, a predicted failure time of the software executing hardware. In some embodiments, the predicted failure time determined from a historical analysis of total power usage and hardware component failures in similar software executing hardware and or hardware components.

In some embodiments, the one or more non-transitory computer readable media include further program instructions stored thereon that when executed cause the one or more computers to determine, by the one or more processors, if the predicted failure time is before the scheduled maintenance time. Some embodiments include a step to determine, by the one or more processors, a power usage plan for the software executing hardware that results in a failure prediction time that is greater than or equal to the scheduled maintenance time.

In some embodiments, the one or more non-transitory computer readable media include further program instructions stored thereon that when executed cause the one or more computers to generate, by the one or more processors, a power usage plan for the software executing hardware and/or the hardware component. In some embodiments, the power usage plan comprises a power limit for the software executing hardware.

In some embodiments, the one or more non-transitory computer readable media include further program instructions stored thereon that when executed cause the one or more computers to assign, by the one or more processors, one or more programs to the software executing hardware that includes a software power usage that results in an adjusted failure time for the software executing hardware that is greater than a predicted failure time.

Some embodiments include a step to determine, by the one or more processors, software power usage for each of a plurality of programs. Some embodiments include a step to generate, by the one or more processors, an execution schedule for the software executing hardware based on the software power usage for each of a plurality of programs. In some embodiments, the execution schedule comprises one or more of: a program list, a software power usage for each of the programs on the program list, a current power usage for the software executing hardware, a predicted power usage for the software executing hardware, and a maintenance prediction.

Some embodiments include a step to store, by the one or more processors, a software power usage, the software power usage comprising the additional power measurement and an association of the additional power measurement to the one or more programs. Some embodiments include a step to determine, by the one or more processors, a customer power usage, the customer power usage comprising the software power usage. In some embodiments, the customer power usage comprises a software power usage during the execution of an SaaS service. In some embodiments, the one or more non-transitory computer readable media include further program instructions stored thereon that when executed cause the one or more computers to generate, by the one or more processors, a customer bill, the customer bill based on the software power usage.

### DRAWING DESCRIPTION

FIG. 1 shows a non-limiting example of system hardware architecture according to some embodiments.

FIG. 2 illustrates a deployed hardware configuration according to some embodiments.

FIG. 3 depicts a raspberry PI device located on the back of the hardware cluster according to some embodiments.

FIG. 4 depicts a power supply wiring example according to some embodiments.

FIG. 5 shows a table of hardware components according to some embodiments.

FIG. 6 illustrates a graphical user interface showing power trends of a baseline unloaded idle computer and a loaded computer executing software according to some embodiments.

FIG. 7 illustrates a system data flow architecture according to some embodiments.

FIG. 8 illustrates a computer system enabling or comprising the system and methods in accordance with some embodiments.

### DETAILED DESCRIPTION

In some embodiments, the disclosure is directed to systems and/or methods (collectively referred to herein as the “system”) for measuring energy usage of software. In some embodiments, the system is configured to measure energy usage of the execution of one or more software programs. In some embodiments, the system is configured to measure the energy usage of one or more hardware components as a result of the execution of the one or more programs. In some embodiments, the system is configured to predict hardware component maintenance and/or lifetime based on component usage during the execution of the one or more programs. In some embodiments, the system is configured to enable a calculation of carbon emissions based on energy usage as the result of the execution of one or more programs.

In some embodiments, the system is configured to accurately (+0.01 Watts) measure the energy consumption of application software. In some embodiments, the electrical energy provided to the device is accurately measured using a high-precision benchtop power supply. In some embodiments, the precision of the energy measurements is at least 0.01 Watts.

The following steps describe how to make and use aspects of the system for software energy measurement according to some embodiments. While some specific hardware names are used, it is understood that the names can be changed to more generic and/or genus terms when describing the metes and bounds of the system.
Step 1: Obtain a small form factor computer with an external direct current (DC) power supply.
Step 2: Replace the original power supply with a high-precision bench-top laboratory power supply.
Step 3: Preset the voltage to the required value and measure current, power and energy consumed by the small form factor PC during operation.
Step 4: Use two identical setups as described in Steps 1 through 3.
Step 5: On the first setup install the software and applications that need to be measured: start a typical application load on the first system; leave the second setup in its original condition.
Step 6: Measure the energy consumption of both systems.
Step 7: Calculate the difference of energy usage between the system under load (system 1) and the idling system (system 2) as the consumed energy by the software.

The following steps describe how to make and use aspects of the system for software energy data archival according to some embodiments.
Step 1: Connect the precision bench top power supplies to a Raspberry PI device via USB (serial) or Ethernet port.
Step 2: Use the power supply's serial port programming interface to query the power supplies measurement values (Voltage, Current, Power, Energy) and transform the results into MQTT messages using a Python script.
Step 3: Send the MQTT messages to PI Archive and Data Hub using the MQTT PI Adaptor.
Step 4: Archive data for analysis

The following steps describe how to make and use aspects of the system for predicting software energy usage using AI and/or supervised machine learning according to some embodiments.
Step 1: Archive energy usage data.
Step 2: Capture operating system performance data and archive it together with the energy usage data.
Step 3: Build an AI and/or supervised machine learning model, (e.g. linear regression and/or a neural network) based on sample data (step 1 and Step 2).
Step 4: Predict energy consumption using only operating system performance data and the prediction model that has been trained in Step 3.

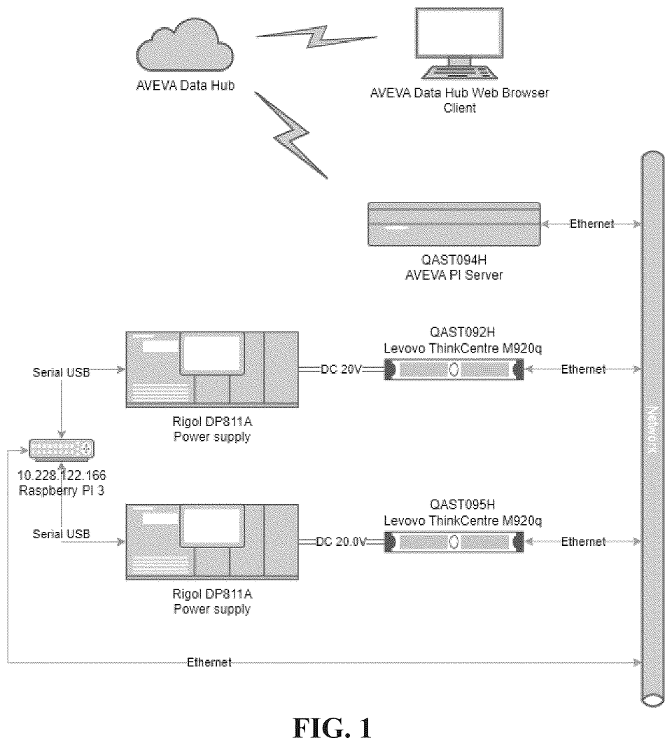

FIG. 1 shows a non-limiting example system hardware architecture according to some embodiments. In some embodiments, the system includes one or more data hubs, clients, servers, power supplies, communication networks, and/or sensors.

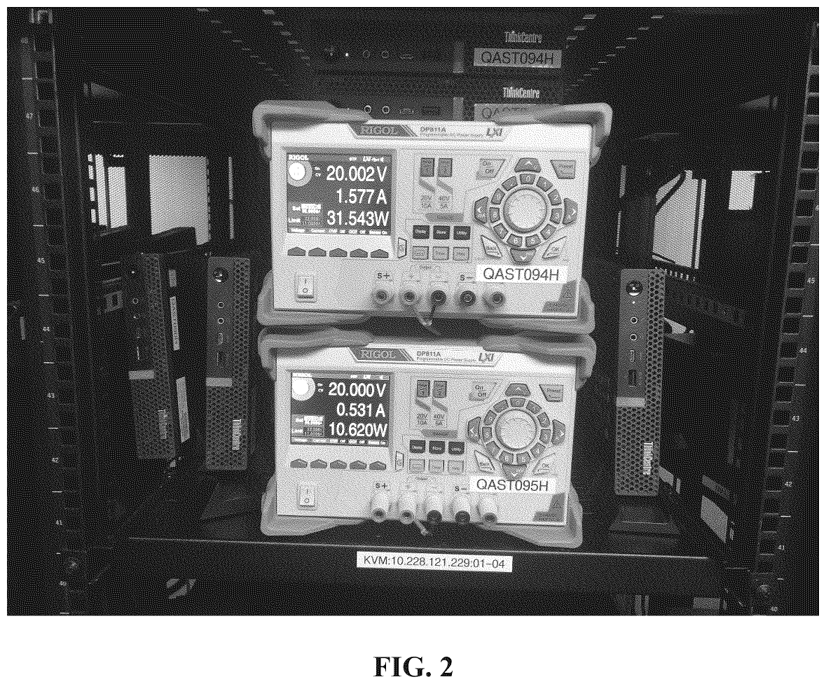

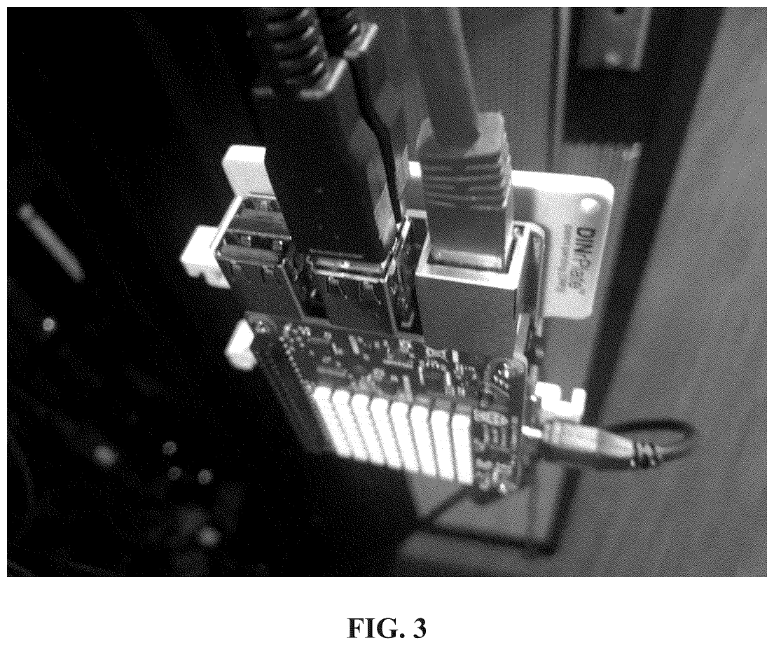

FIG. 2 illustrates a deployed hardware configuration according to some embodiments. FIG. 3 depicts a raspberry PI device located on the back of the hardware cluster according to some embodiments. In some embodiments, the system includes one or more small form factor computers powered by bench top power supplies instead of the power bricks that ship with the computers. In some embodiments, the power bricks in this non-limiting example deliver a constant voltage of 20.0V and are rated for a maximum power of 135 W. In some embodiments, the power bricks provide a peak current of 6.575 A. In some embodiments, the Rigol DP811A power supplies have one channel that can support a peak current of 10 A at 20V.

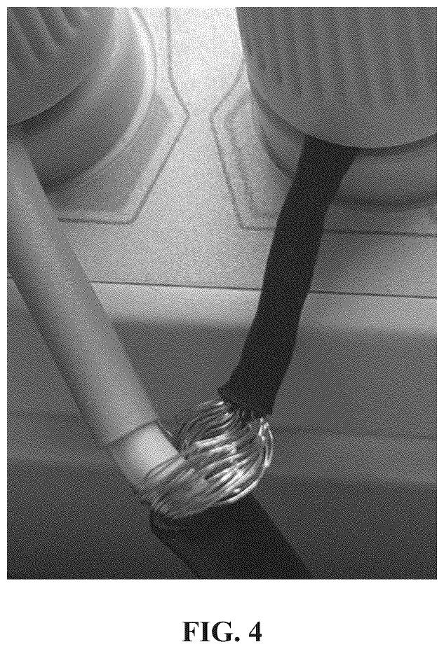

FIG. 4 depicts a power supply wiring example according to some embodiments. In some embodiments, one or more assembly steps include power cord modification. In some embodiments, a DC power brick has two cables attached to it: one cable is a power cable supplying the bricks with 120V AC power; the other end of the PC power supply carries DC power to the Small Form Factor PC. In some embodiments, the other end plugs into the PC using a 6 mm male barrel connector, as a non-limiting example.

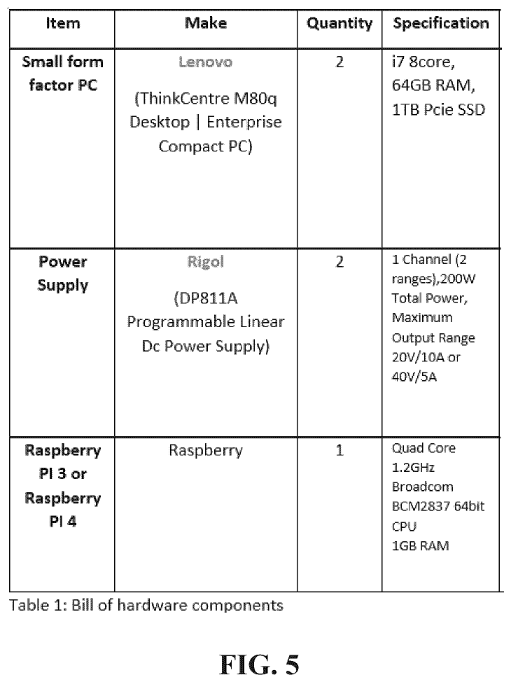

In some embodiments, the power cable end of the Lenovo power supply can be reused. In some embodiments, an assembly step includes cutting the cord close to the power brink and measure the polarity and voltage using a multi-meter. In some embodiments, a step includes marking the polarity of the two wires. In some embodiments, a step includes connecting the wires to the correct terminals of the 20V Channel of the Rigol power supply. In some embodiments, the wire with the white insulation connects to the plus terminal and the silver wire strands connect to the minus terminal of the power supply. FIG. 5 shows a table of hardware components according to some embodiments.

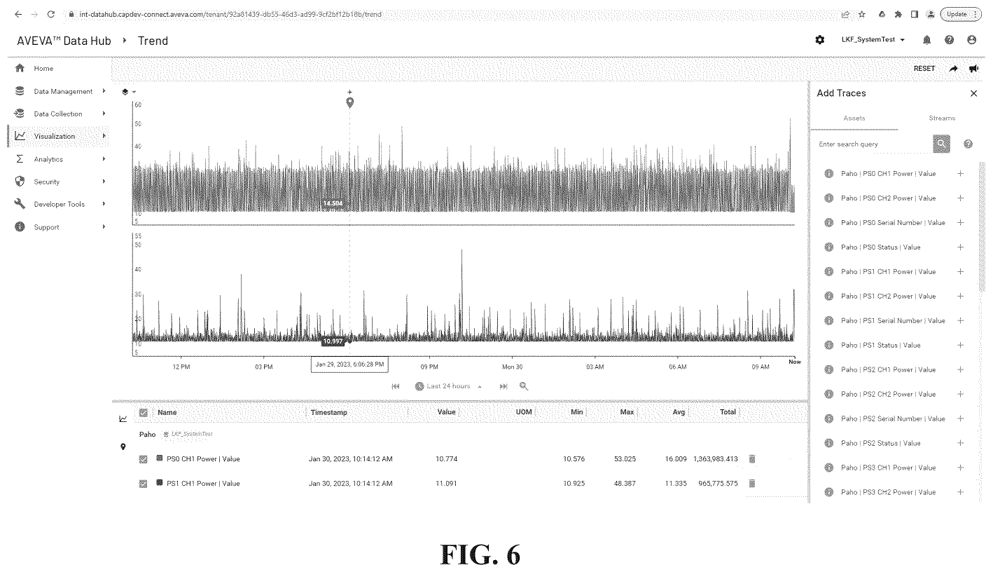

FIG. 6 illustrates a graphical user interface shown power trends of a baseline unloaded computer and a loaded computer executing software according to some embodiments. In some embodiments, to calculate the power consumption, two measurements are required:
(i) Baseline (Software Not Running): Power consumption of a system with just the operating system as it is provided by the hardware manufacturer or delivered by the IT team as a brand-new operating system deployment.
(ii) Loaded System (Software Running): Power consumption of the Baseline system plus: Product Pre-Requisites (e.g., SQL Server); Product installation (e.g., System Platform-All-In-One); Application Deployment (e.g., Soak Test Application); and Data simulation if applicable.

In some embodiments, the resulting energy consumption is the difference between both measurements. In some embodiments, energy consumption is calculated as the average of the power measurements times their duration. In some embodiments, the duration of the measurements is application specific and related to the typical application lifecycle.

In some embodiments, configuration options include one computer (sequential measurement) or two identical computers (parallel measurement). In some embodiments, for a sequential measurement, the baseline measurement and the loaded system measurement are performed on the same computer in sequential order. In some embodiments, this has the advantage that only one computer is needed. In some embodiments, for a parallel measurement, the baseline measurement and the loaded system measurement are performed in parallel by running the baseline on the first computer and the loaded system on the identical second computer. In some embodiments, the advantage of the second configuration is that the power consumption is configured to be calculated continuously and/or in substantially real time.

In some embodiments, the system includes an ability to archive data in one more databases. FIG. 6 shows the power measurements of the baseline and loaded system (parallel configuration) over time. In some embodiments, aspects of the system include receiving, by one or more processors, archived data from one or more databases.

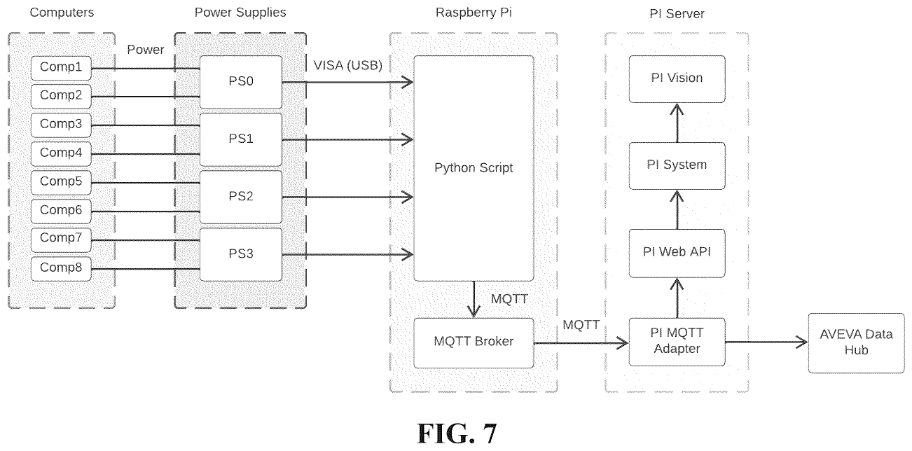

In some embodiments, measurements are collected by the Raspberry PI device (e.g., Voltage, Current, Power and Energy) and stored in at least one database (e.g., AVEVA® Datahub) for data archival and further consumption and analysis. In some embodiments, the system is configured to automatically collect and store the power readings of one or more power supplies. FIG. 7 illustrates a system data flow architecture according to some embodiments.

In some embodiments, there are two main ways to set up a new Raspberry Pi device: (1) by creating a copy of the image of the original by, or (2) by setting up a new one completely from scratch. In some embodiments, the following instruction are for setting up a headless Pi.

In some embodiments, creating a new image includes one or more of the following steps.
1. Download and open the Raspberry Pi Imager
2. Plug in an SD Card
3. Choose Raspberry Pi Lite as the operating system, and the SD card as the Storage
4. Configure settings by pressing the gear button on the bottom right
   i) If there is more than one Pi on the same network, change the default hostname
   ii) Enable SSH and set a username and password
   iii) Set up wifi and/or use ethernet
   iv) Set the region
5. Write to the SD card by pressing write
6. Once it has finished writing, remove the SD card and plug it into the Pi
7. Connect the Pi to ethernet and power
8. SSH into the Pi (or some other form of remote connection)
   ssh {username}@{hostname}.local
   ssh {username}@{ipaddress}
9. Open the terminal and update the system
   sudo apt-get update
   sudo apt-get upgrade
   i) In some embodiments, there might be an error that a certain file is not valid yet. In some embodiments, a user will have to update the time manually: sudo date-s ‘YYYY-MM-DD HH:MM
   ii) rerun the update commands and ensure no errors
11. Install pip
   sudo apt-get install python3-pip
12. Install the necessary python libraries
   pip3 install paho-mqtt pyvisa pyvisa-py pyusb
13. Give users access to USB devices
   wget https://techoverflow.net/scripts/udev-install-usbusers.sh|sudo bash−s $USER sudo nano/etc/udev/rules.d/99-com.rules
   1) This should open the .rules file
   2) Scroll down using the arrow keys to the bottom of all the subsystem commands
   3) Add the line: SUBSYSTEM==“usb”, GROUP=“usbusers”, MODE=“0666” to the bottom of those commands
   4) Exit the file by pressing ctrl x, y, enter
   5) Reboot the system: sudo reboot
14. SSH back into the Pi once it powers back on
15. Download the ConnectMQTT.py, rigol.py, and test.py files and save them in home/{username}
16. Try running the test.py file to see if everything is working correctly: python3 /home/{username}/test.py
   Should see a list of all the connected power supplies in the terminal
   Make sure all the instruments attached are discoverable (they are powered on)
17. Set the script to run at startup
   Edit the .bashrc file: sudo nano /home/{username}/.bashrc
   Add the following to the end of the file:
   echo Running at boot
   python3 /home/{username}/connectMQTT.py|& sudo tee /home /{username}/log.txt
      see error messages and stdout in the log.txt file for debugging
   Exit the file by pressing ctrl x, y, enter
18. If there are no errors test to see if everything runs at startup: sudo reboot
   Should be able to see messages being sent to the MQTT broker

In some embodiments, the following instructions provide a method for connecting to Data Hub from Jupyter NB.

| | |
|---|---|
| 1. | Necessary libraries: ipywidgets, ipydatetime, matplotlib, adh_sample_library_preview |
| | (all can be installed through pip) |
| 2. | Create a file named appsettings.json in the following format: { |
| | “Resource”: “PLACEHOLDER_REPLACE_WITH_RESOURCE_PATH”, |
| | “ApiVersion”: “v1”, |
| | “TenantId”: “PLACEHOLDER_REPLACE_WITH_TENANT_ID”, |
| | “NamespaceId”: “PLACEHOLDER_REPLACE_WITH_NAMESPACE_ID”, |
| | “CommunityId”: null, |
| | “ClientId”: “PLACEHOLDER_REPLACE_WITH_CLIENT_IDENTIFIER”, |
| | “ClientSecret”: “PLACEHOLDER_REPLACE_WITH_CLIENT_SECRET” |
| | } |
| 3. | Run in Jupyter NB or Lab |

In some embodiments, the following instruction provide a method for finding information:
1. Resource Path: the root of Data Hub's URL (everything before /tenant)
2. Tenant ID: The string of numbers after /tenant/ in the URL
3. Namespace ID: In the top right of the page there is a drop down beside the gear symbol. The user is able to copy the string of numbers in the namespace the data is stored in
4. Client ID and Secret: If a client hasn't already been created that can only read you are able to do so Security->Clients. The Client Secret is only availed when the Client is created

In some embodiments, a step includes targeting a median application size of a single node system. For example, in some embodiments, if the majority of tag or IO count licenses sold for a single node system is 10,000, then use this kind of application. In some embodiments, a system platform includes a 10,000 I/O single node system.

In some embodiments, the system platform includes a continuous steady-state runtime scenario because this is where the application consumes power in at least 90% of the total application life cycle.

In some embodiments, auxiliary applications are also configured to be measured as long as they run on the same machine. In some embodiments, the system platform is configured to run the GE OI Server and the GE Simulator on the system that is being measured.

In some embodiments, the system and methods described herein enables accurate measuring of the amount of energy a software uses, as opposed to guessing a value for the power consumption. In some embodiments, the system includes a syntheses of a data model for power consumption configured to increase in accuracy over time by accounting for more and more parameters.

In some embodiments, the system includes a (Flex) Service as a Subscription (SaaS). In some embodiments, the system is configured to determine energy consumption for each of one or more users of the SaaS. In some embodiments, the system is configured to report energy usage through an MQTT. In some embodiments, the system is configured to send, by one or more processors, historical and/or predicted energy usage to one or more analytic platforms. In some embodiments, one or more analytic platforms include predictive maintenance analytic platforms. In some embodiments, the system is configured to calculate hardware component life using one or more software energy measurements. In some embodiments, the system is configured to execute software programs on specific hardware (e.g., servers) based on software energy usage. In some embodiments, the system is configured to execute software programs in one or more geographical regions based on software energy usage. As a non-limiting example, in some embodiments, the system is configured to execute lower energy using programs on components with a lower life. In some embodiments, the system is configured to use artificial intelligence to identify combinations of programs resulting in a lowest energy consumption.

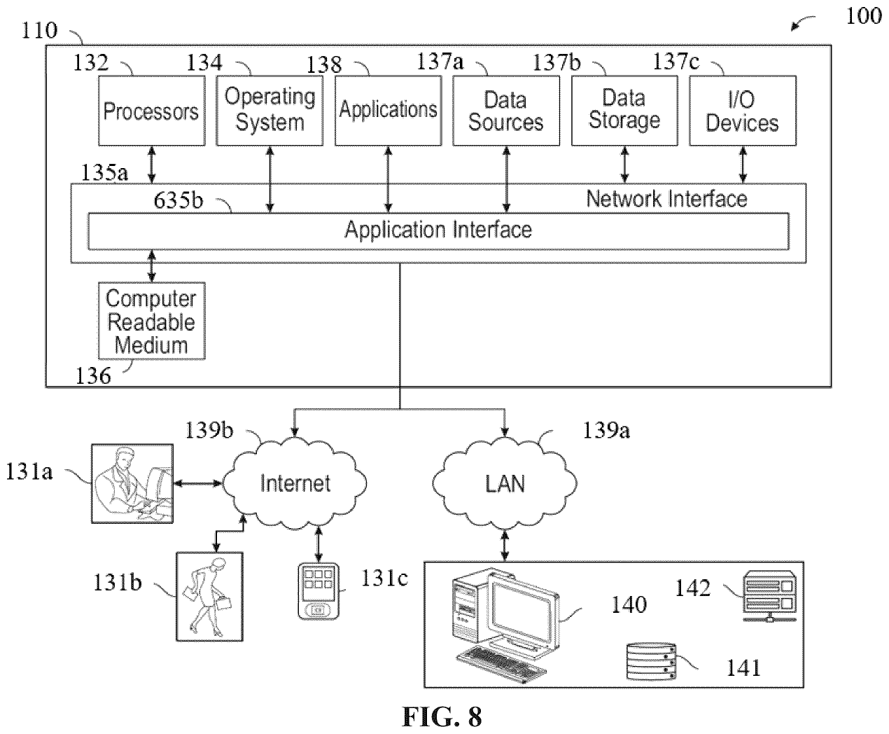

FIG. 8 illustrates a computer system 110 enabling or comprising the systems and methods in accordance with some embodiments. In some embodiments, the computer system 110 is configured to operate and/or process computer-executable code of one or more software modules of the aforementioned system and method. Further, in some embodiments, the computer system 110 is configured to operate and/or display information within one or more graphical user interfaces (e.g., HMIs) integrated with or coupled to the system.

In some embodiments, the computer system 110 comprises one or more processors 132. In some embodiments, at least one processor 132 resides in, or is coupled to, one or more servers. In some embodiments, the computer system 110 includes a network interface 135a and an application interface 135b coupled to the least one processor 132 capable of processing at least one operating system 134. Further, in some embodiments, the interfaces 135a, 135b coupled to at least one processor 132 are configured to process one or more of the software modules (e.g., such as enterprise applications 138). In some embodiments, the software application modules 138 includes server-based software. In some embodiments, the software application modules 138 are configured to host at least one user account and/or at least one client account, and/or configured to operate to transfer data between one or more of these accounts using one or more processors 132.

With the above embodiments in mind, it is understood that the system is configured to implements various computer-implemented program steps involving data stored one or more non-transitory computer media according to some embodiments. In some embodiments, the above-described databases and models described throughout this disclosure are configured to store analytical models and other data on non-transitory computer-readable storage media within the computer system 110 and on computer-readable storage media coupled to the computer system 110 according to some embodiments. In addition, in some embodiments, the above-described applications of the system are stored on computer-readable storage media within the computer system 110 and on computer-readable storage media coupled to the computer system 110. In some embodiments, these operations are those requiring physical manipulation of structures including electrons, electrical charges, transistors, amplifiers, receivers, transmitters, and/or any conventional computer hardware in order to transform an electrical input into a different output. In some embodiments, these structures include one or more of electrical, electromagnetic, magnetic, optical, and/or magneto-optical signals capable of being stored, transferred, combined, compared and otherwise manipulated. In some embodiments, the computer system 110 comprises at least one computer readable medium 136 coupled to at least one of at least one data source 137a, at least one data storage 137b, and/or at least one input/output 137c. In some embodiments, the computer system 110 is embodied as computer readable code on a computer readable medium 136. In some embodiments, the computer readable medium 136 includes any data storage that stores data, which is configured to thereafter be read by a computer (such as computer 140). In some embodiments, the non-transitory computer readable medium 136 includes any physical or material medium that is used to tangibly store the desired information, steps, and/or instructions and which is configured to be accessed by a computer 140 or processor 132. In some embodiments, the non-transitory computer readable medium 136 includes hard drives, network attached storage (NAS), read-only memory, random-access memory, FLASH based memory, CD-ROMs, CD-Rs, CD-RWs, DVDs, magnetic tapes, and/or other optical and non-optical data storage. In some embodiments, various other forms of computer-readable media 136 are configured to transmit or carry instructions to one or more remote computers 140 and/or at least one user 131, including a router, private or public network, or other transmission or channel, both wired and wireless. In some embodiments, the software application modules 138 are configured to send and receive data from a database (e.g., from a computer readable medium 136 including data sources 137a and data storage 137b that comprises a database), and data is configured to be received by the software application modules 138 from at least one other source. In some embodiments, at least one of the software application modules 138 are configured to be implemented by the computer system 110 to output data to at least one user 131 via at least one graphical user interface rendered on at least one digital display.

In some embodiments, the one or more non-transitory computer readable 136 media are distributed over a conventional computer network via the network interface 135a where some embodiments stored the non-transitory computer readable media are stored and executed in a distributed fashion. For example, in some embodiments, one or more components of the computer system 110 are configured to send and/or receive data through a local area network (“LAN”) 139a and/or an internet coupled network 139b (e.g., such as a wireless internet). In some embodiments, the networks 139a, 139b include one or more wide area networks (“WAN”), direct connections (e.g., through a universal serial bus port), or other forms of computer-readable media 136, and/or any combination thereof.

In some embodiments, components of the networks 139a, 139b include any number of personal computers 140 which include for example desktop computers, laptop computers, and/or any fixed, generally non-mobile internet appliances coupled through the LAN 139a. For example, some embodiments include one or more personal computers 140, databases 141, and/or servers 142 coupled through the LAN 139a that are configured for use by any type of user including an administrator. Some embodiments include one or more personal computers 140 coupled through network 139b. In some embodiments, one or more components of the computer system 110 are configured to send or receive data through an internet network (e.g., such as network 139b). For example, some embodiments include at least one user 131a, 131b, coupled wirelessly and accessing one or more software modules of the system including at least one enterprise application 138 via an input and output (“I/O”) 137c. In some embodiments, the computer system 110 is configured to enable at least one user 131a, 131b, to be coupled to access enterprise applications 138 via an I/O 137c through LAN 139a. In some embodiments, the user 131 includes a user 131a coupled to the computer system 110 using a desktop computer, and/or laptop computers, or any fixed, generally non-mobile internet appliances coupled through the internet 139b. In some embodiments, the user includes a mobile user 131b coupled to the computer system 110. In some embodiments, the user 131b connects using any mobile computing 131c to wireless coupled to the computer system 110, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of energy efficiency by providing a way to accurately measure the energy consumed during the execution of one or more software programs. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system comprising for measuring energy usage of software comprising:
one or more computers comprising one or more processors and one or more non-transitory computer readable media, the one or more non-transitory computer readable media including program instructions stored thereon that when executed cause the one or more computers to:
receive, by the one or more processors, a baseline power measurement from software executing hardware, the baseline power measurement comprising a power usage of the software executing hardware component during an idle time period;
receive, by the one or more processors, a loaded power measurement of the software executing hardware, the loaded power measurement including the baseline power measurement and an additional power measurement, the additional power measurement comprising power used by the software executing hardware during the execution of one or more programs;
determine, by the one or more processors, the additional power measurement by determining a difference between the baseline power measurement and the loaded power measurement;
store, by the one or more processors, a software power usage, the software power usage comprising the additional power measurement and an association of the additional power measurement to the one or more programs; and
execute, by the one or more processors, the one or more programs on the software executing hardware based on the software power usage.

2. The system of claim 1,
wherein the one or more non-transitory computer readable media include further program instructions stored thereon that when executed cause the one or more computers to:
receive, by the one or more processors, a maintenance prediction for a hardware component of the software executing hardware.

3. The system of claim 2,
wherein the maintenance prediction includes a failure prediction for the hardware component.

4. The system of claim 3,
wherein the maintenance prediction includes a correlation between total power usage and the failure prediction.

5. The system of claim 3,
wherein the maintenance prediction includes a correlation between the software power usage and the failure prediction.

6. The system of claim 1,
wherein the one or more non-transitory computer readable media include further program instructions stored thereon that when executed cause the one or more computers to:
determine, by the one or more processors, a predicted failure time of the software executing hardware.

7. The system of claim 6,
wherein the predicted failure time determined from a historical analysis of total power usage and hardware component failures in similar software executing hardware.

8. The system of claim 7,
wherein the one or more non-transitory computer readable media include further program instructions stored thereon that when executed cause the one or more computers to:
determine, by the one or more processors, if the predicted failure time is before the scheduled maintenance time.

9. The system of claim 8,
wherein the one or more non-transitory computer readable media include further program instructions stored thereon that when executed cause the one or more computers to:
determine, by the one or more processors, a power usage plan for the software executing hardware that results in a failure prediction time that is greater than or equal to the scheduled maintenance time.

10. The system of claim 7,
wherein the one or more non-transitory computer readable media include further program instructions stored thereon that when executed cause the one or more computers to:
generate, by the one or more processors, a power usage plan for the software executing hardware and/or the hardware component.

11. The system of claim 10,
wherein the power usage plan comprises a power limit for the software executing hardware.

12. The system of claim 1,
wherein the one or more non-transitory computer readable media include further program instructions stored thereon that when executed cause the one or more computers to:
assign, by the one or more processors, one or more programs to the software executing hardware that includes a software power usage that results in an adjusted failure time for the software executing hardware that is greater than a predicted failure time.

13. The system of claim 1,
wherein the one or more non-transitory computer readable media include further program instructions stored thereon that when executed cause the one or more computers to:
determine, by the one or more processors, software power usage for each of a plurality of programs.

14. The system of claim 13,
wherein the one or more non-transitory computer readable media include further program instructions stored thereon that when executed cause the one or more computers to:
generate, by the one or more processors, an execution schedule for the software executing hardware based on the software power usage for each of a plurality of programs.

15. The system of claim 14,
wherein the execution schedule comprises one or more of:
a program list,
a software power usage for each of the programs on the program list,
a current power usage for the software executing hardware,
a predicted power usage for the software executing hardware, and
a maintenance prediction.

16. A system comprising for measuring energy usage of software comprising:
one or more computers comprising one or more processors and one or more non-transitory computer readable media, the one or more non-transitory computer readable media including program instructions stored thereon that when executed cause the one or more computers to:
receive, by the one or more processors, a baseline power measurement from software executing hardware, the baseline power measurement comprising a power usage of the software executing hardware component during an idle time period;
receive, by the one or more processors, a loaded power measurement of the software executing hardware, the loaded power measurement including the baseline power measurement and an additional power measurement, the additional power measurement comprising power used by the software executing hardware during the execution of one or more programs;
determine, by the one or more processors, the additional power measurement by determining a difference between the baseline power measurement and the loaded power measurement;
store, by the one or more processors, a software power usage, the software power usage comprising the additional power measurement and an association of the additional power measurement to the one or more programs; and
determine, by the one or more processors, a customer power usage, the customer power usage comprising the software power usage.

17. The system of claim 16,
wherein the customer power usage comprises a software power usage during the execution of an SaaS service.

18. The system of claim 17,
wherein the one or more non-transitory computer readable media include further program instructions stored thereon that when executed cause the one or more computers to:
generate, by the one or more processors, a customer bill, the customer bill based on the software power usage.
